(19) United States
(12) Patent Application Publication
(10) Pub. No.: US 2004/0247218 A1
(43) Pub. Date: Dec. 9, 2004

(54) Optoelectronic device

(76) Inventors: Charles Norman Ironside, Glasgow (GB); Jose Maria Longras Figueiredo, Faro (PT)

Correspondence Address: STITES & HARBISON PLLC, 1199 NORTH FAIRFAX STREET, SUITE 900, ALEXANDRIA, VA, 22314, US

(21) Appl. No.: 10/475,744

(22) PCT Filed: Apr. 25, 2002
(86) PCT No.: PCT/GB02/01930

(30) Foreign Application Priority Data
Apr. 25, 2001 (GB) 0110112.0

(51) Int. Cl. G02F 1/01

(52) U.S. Cl. 385/1

(57) ABSTRACT

There is disclosed an optoelectronic device, particularly an optoelectronic modulator (5a) including a resonant tunnelling diode (RTD) (15a) and operating by the electro-optic effect. The optoelectronic modulator device (5a) comprises a waveguide means (10a) including at least one resonant tunnelling diode (RTD) (15a), and wherein a change in absorption coefficient of a semiconductor material of the device with applied electric field is negligible at a wavelength of operation. In this way the device (5a) operates substantially solely by the electro-optic effect providing a change in refractive index of the waveguide (10a). The device (5a) may therefore act as a phase modulator. The device (15a) is conveniently termed a Resonant Tunnelling Diode Electro-optic Modulator (RTD-EOM).

### FIELD OF INVENTION

This invention relates to an improved optoelectronic device, and in particular, to an optoelectronic modulator including a resonant tunnelling diode (RTD) and operating by the electro-optic effect.

### BACKGROUND TO INVENTION

WO 00/72383, also by the same applicant, discloses an optoelectronic modulator device including a resonant tunnelling diode (RTD), operation of the device being based upon electro-absorption effects. Such a device has been termed an “RTD-EAM”, and may suffer from a number of problems for particular uses.

It is therefore an object of the present invention to seek to address such problems by providing an alternative optoelectronic modulator device.

### SUMMARY OF INVENTION

According to a first aspect of the present invention there is provided an optoelectronic modulator device comprising a waveguide means including at least one resonant tunnelling diode (RTD), and wherein a change in absorption coefficient of a semiconductor material of the device with applied electric field is negligible at a wavelength of operation.

In this way the device may operate substantially solely by the electro-optic effect providing a change in refractive index of the waveguide. The device may therefore act as a phase modulator.

The device may conveniently be termed a Resonant Tunnelling Diode Electro-optic Modulator (RTD-EOM).

Preferably the said semiconductor material comprises a part of a core layer of the waveguide means.

The device may be adapted for use in a waveguide range 1000 to 1600 nm, or alternatively 600 to 900 nm.

Preferably the optoelectronic modulator device is made at least partially from a quaternary III-v semiconductor alloy.

The quaternary III-V semiconductor alloy may advantageously be Indium Gallium Aluminium Arsenide (InGaAlAs). Alternatively, the quaternary III-V semiconductor alloy may be Indium Gallium Arsenide Phosphide (InGaAsP).

A quaternary III-V semiconductor alloy layer may be provided on at least one side, and preferably both sides of the RTD.

The RTD may be made at least partly from Indium Gallium Arsenide (InGaAs).

The device may include one or more Multiple Quantum Wells (MQWs).

According to a second aspect of the present invention tthere is provided an optoelectronic modulator device comprising a waveguide means including at least one resonant tunnelling diode (RTD), and wherein a semiconductor material of the device is selected to have a band-gap which resonantly enhances the electro-optic effect at a wavelength of operation.

According to a third aspect of the present invention there is provided an optoelectronic modulator device comprising at least one input, at least one output, and first and second waveguides, at least one of the first or second waveguides including at least one resonant tunnelling diode (RTD), and wherein a change in absorption coefficient of a semiconductor material of the device with applied electric field is negligible at a wavelength of operation.

In one embodiment the device may comprise a Mach-Zender interferometer.

In another embodiment the device may comprise a directional coupler.

According to a fourth aspect of the present invention there is provided a base station of a communication network, the station including at least one optoelectronic device according to the first to third aspects.

According to a fifth aspect of the present invention there is provided a communication network including at least one optoelectronic device according to the first to third aspects.

According to a sixth aspect of the present invention there is provided use of Resonant Tunnelling Diode (RTD) structure to switch an electric field in a semiconductor waveguide and thereby alter a refractive index of the semiconductor waveguide via the electro-optic effect.

The semiconductor waveguide may consist of a core of semiconductor surrounded by a lower refractive index material. The core semiconductor may be any semiconductor alloy or semiconductor nanostructure such as a single or Multiple Quantum Wells (MQWs).

The RTD may consist of semiconductor layers which employ quantum mechanical tunnelling between layers to produce a device which has a current voltage characteristic that has a negative differential resistance.

The RTD switched electric field producing the change in refractive index may be used in the optical waveguide to produce a controllable phase change in the light propagating in the waveguide.

The phase change in the light can be employed in device configurations such as Mach-Zender interferometers and directional couplers to switch or modulate the light in the devices.

According to a seventh aspect of the present invention there is provided use of an RTD structure to switch an electric field in a semiconductor material and thereby alter the refractive index of the semiconductor via the electro-optic effect and consequently control the phase of a light beam exiting the material.

According to an eighth aspect of the present invention there is provided use of semiconductor alloys and/or semiconductor nanostructures such as Quantum Wells (QW) that have a band-gap selected to increase the electro-optic effect at any wavelength of interest in combination with an RTD to switch the electric field.

### BRIEF DESCRIPTION OF DRAWINGS

Embodiments of the present invention will now be described by way of example only, and with reference to the accompanying drawings, which are:

FIG. 1 a schematic sectional end view of an optoelectronic modulator device according to a first embodiment of the present invention;

FIG. 2 a schematic view of a band-edge through a wafer structure used in fabrication of the device of FIG. 1 with no applied electric field;

FIGS. 3(a) and (b) schematic sectional views of the band-edge through part of the wafer structure of FIG. 2 without and with an applied electric field applied respectively;

FIG. 4 a graphical representation of absorption (a) against wavelength (x) for a given semiconductor material;

FIG. 5 a schematic view from above of an optoelectronic modulator device according to a second embodiment of the present invention; and

FIG. 6 a schematic view from above of an optoelectronic modulator device according to a third embodiment of the present invention.

### DETAILED DESCRIPTION OF DRAWINGS

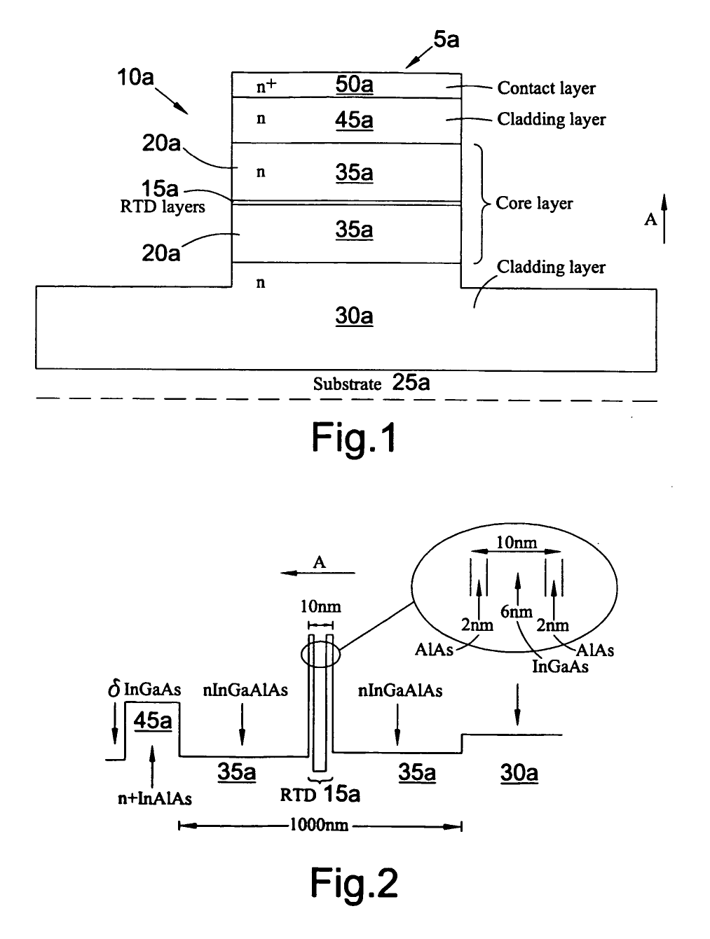

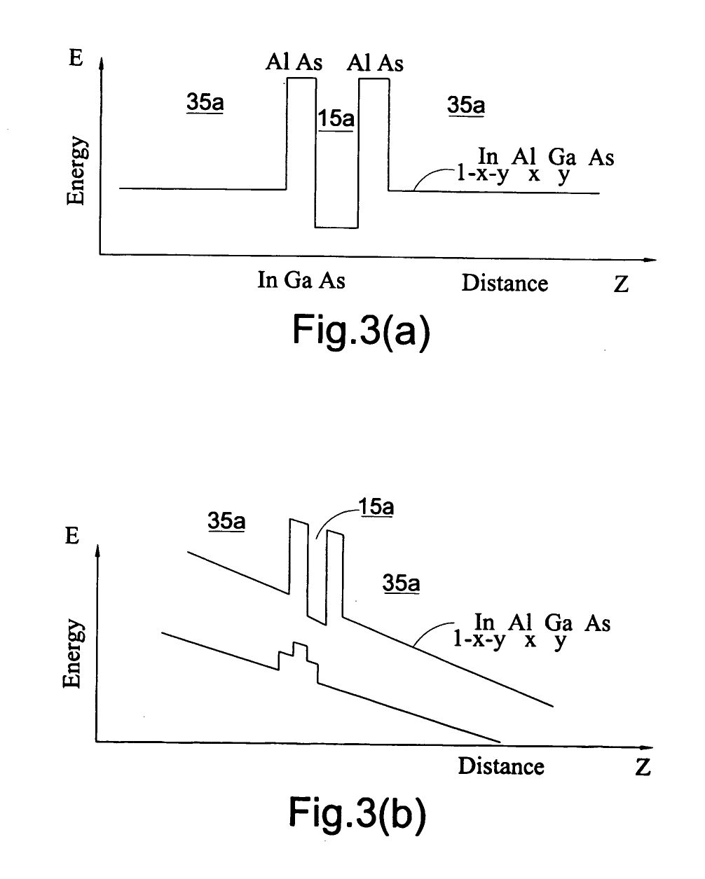

Referring initially to FIGS. 1 to 4 there is illustrated an optoelectronic modulator device according to a first embodiment of the present invention, generally designated 5a. The device 5a comprises a waveguide means 10a including at least one resonant tunnelling diode (RTD) 15a, wherein, in use, a change in absorption coefficient of a semiconductor material 20a of the device 5a with applied electric field is negligible (ie has no operative effect) at a wavelength of operation λ_{c}. The semiconductor material 20a is selected to have a band-gap which resonantly enhances the electro-optic effect at the wavelength of operation λ_{c}. The device 5a has conveniently been termed a Resonant Tunnelling Diode Electro-Optic Modulator (RTD-EOM).

In this way the device 5a operates substantially wholly by the electro-optic effect, in use, providing a change in refractive index of the waveguide means 10a. The device 5a therefore acts as a phase modulator.

In a preferred implementation the semiconductor material is Indium Aluminium Gallium Arsenide (In_{1-x-y}Al_{z}Ga_{y}As), and the device 5a operates at a wavelength in the region 1000 to 1600 nm.

The device 5a comprises a substrate 25a, first cladding layer 30a, core (guiding) layer 35a, including a resonant tunnelling diode 15a, second cladding layer 45a, and contact layer 50a. As can be seen from FIG. 1, the first and second cladding layers 30a, 45a and core layer 35a are suitably formed, eg by etching, into waveguide means 10a in the form of a ridge waveguide.

A semiconductor alloy or semiconductor nanostructure of the core layer 35a has its band-gap at a higher energy than the photon energy of the guided light in the waveguide means 10a. This results in a change in refractive index but a minimal change in the absorption.

The contact layer 50a is a heavily doped semiconductor. The first and second cladding layers 30a, 45a are made of semiconductor with a refractive index lower than the core layer 35a, and therefore could in InAlAs. The core layer 35a has a higher refractive index than the cladding layers 30a, 45a, and has a band-gap energy larger than the photon energy of the light which is to be modulated. For example, the core layer 35a could be an alloy of InAlGaAs.

Layers of the RTD 15a are incorporated in the core layer 35a to provide a quantum mechanical tunnelling structure that produces a negative differential resistance region in the current-voltage characteristic of the device 5a. For example, the RTD 15a in this embodiment consist of a 2 nm layer of AlAs, a 6 nm layer of InGaAs and a 2 nm layer of AlAs.

The core layer 35a alloy or semiconductor nanostructure can have its band-gap selected to enhance the electro=optic effect at the wavelength of operation λₒ For example, if the wavelength of light which is to be modulated is 1550 m, then an alloy such as InAlGaAs should be selected with In, Al, Ga and As fractions which lattice match to the substrate, eg InP, and produce a band-gap slightly larger than the photon energy at 1550 nm. This will minimise the optical absorption at 1550 nm but will resonantly enhance the electro-optic effect.

In the waveguide means 10a, when the RTD 15a is switched from peak current to valley current, then there is an electric field which appears in the core layer 35a. The electric field alters the refractive index via the electro-optic effect. The change in refractive index alters the phase of the light guided in the waveguide means 10a. Phase modulation of the light is thus produced which can be useful in many applications.

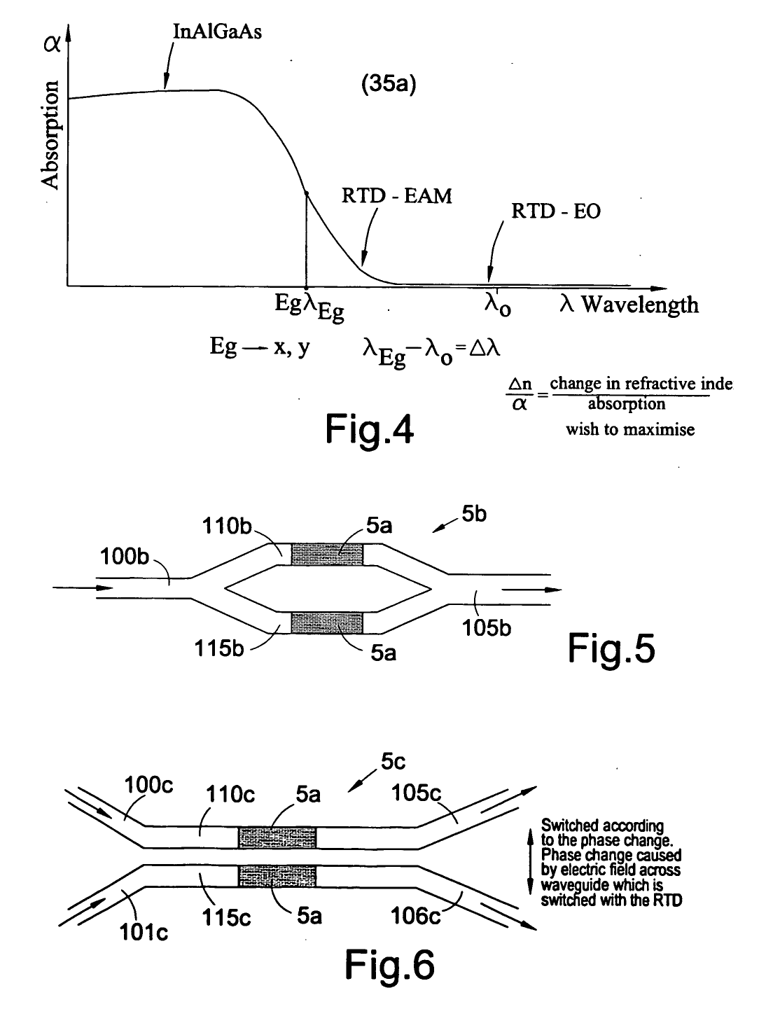

As can be seen from FIG. 4, the absorption coefficient α of the semiconductor material 20a at the wavelength of operation λₒ is effectively zero, and therefore the electro-absorption effect does not participate in the operation of the device 5a.

Referring now to FIG. 5, there is illustrated an optoelectronic modulator device according to a second embodiment of the present invention, generally designated 5b. The device 5b comprises a Mach-Zender interferometer and provides an input 10b, an output 105b and first and second waveguides 110b, 115b therebetween. At least the first waveguide 110b and preferably both waveguides 110b, 115b, includes a device 5a according to the first embodiment hereinbefore described. The device 5a therefore provides phase modulation. The phase change in a limb is produced by an electric field across the waveguide 110b, 115b of that limb, the electric filed being switched by the RTD 15a.

Thus an optical signal input at input 100b may be split between the first and second waveguides 100b, 115b, a portion of the signal passing through first waveguide 100b being phase modulated, the optical signal being recombined at the output 105b and thereby intensity modulated.

Referring now to FIG. 6, there is illustrated an optoelectronic modulator device according to a third embodiment of the present invention, generally designated 5c. The device 5c comprises a directional coupler and provides first and second inputs 100c, 101c, first and second outputs 105c, 106c and first and second waveguides 110c, 115c between the respective inputs and outputs. At least the first waveguide and preferably both waveguides 100c, 115c, include a device 5a according to the first embodiment hereinbefore described.

An optical signal input at input 100c will be directed or switched between either the first or second outputs 105c, 106c according to the phase change, the phase being changed by an electric field across the relevant waveguide 110c, 115c which electric field is switched by the RTD 15a in the device 5a in the relevant waveguide 110c, 115c.

It will be appreciated that the embodiments of the present invention hereinbefore described are given by way of example only, and are not meant to limit the scope thereof in any way.

It will be understood at a principle of the present invention is exploitation of refractive index changes in the semiconductor material of the device produced by an electric field via the electro-optic effect (with minimum —effectively zero—optical absorption change) so as to provide optical phase and possibly intensity modulation.

1. An optoelectronic modulator device comprising a waveguide means including at least one resonant tunnelling diode (RTD), and wherein a change in absorption coefficient of a semiconductor material of the device with applied electric field is negligible at a wavelength of operation.

2. An optoelectronic modulator device as claimed in claim 1, wherein the device operates substantially solely by the electro-optic effect providing a change in refractive index of the waveguide means.

3. An optoelectronic modulator device as claimed in claim 1, wherein the said semiconductor material comprises a part of a core layer of the waveguide means.

4. An optoelectronic modulator device as claimed in claim 1, wherein the device is adapted for use in a waveguide range 1000 to 1600 nm or 600 nm to 900 nm.

5. An optoelectronic modulator device as claimed in claim 1, wherein the optoelectronic modulator device is made at least partially from a quaternary III-v semiconductor alloy.

6. An optoelectronic modulator device as claimed in claim 5, wherein the quaternary III-V semiconductor alloy is Indium Gallium Aluminium Arsenide (InGaAlAs).

7. An optoelectronic modulator device as claimed in claim 5, wherein the quaternary III-V semiconductor alloy is Indium Gallium Arsenide Phosphide (InGaAsP).

8. An optoelectronic modulator device as claimed in claim 1, wherein a quaternary III-V semiconductor alloy layer is provided on at least one side and optionally both sides of the RTD.

9. An optoelectronic modulator device as claimed in claim 1, wherein the RTD is made at least partly from Indium Gallium Arsenide (InGaAs).

10. An optoelectronic modulator device as claimed in claim 1, wherein the device includes one or more Multiple Quantum Wells (MQWs).

11. An optoelectronic modulator device comprising a waveguide means including at least one resonant tunnelling diode (RTD), and wherein a semiconductor material of the device is selected to have a band-gap which resonantly enhances the electro-optic effect at a wavelength of operation.

12. An optoelectronic modulator device comprising at least one input, at least one output, and first and second waveguides, at least one of the first or second waveguides including at least one resonant tunnelling diode (RTD), and wherein a change in absorption coefficient of a semiconductor material of the device with applied electric field is negligible at a wavelength of operation.

13. An optoelectronic modulator device as claimed in claim 12, wherein the device comprises a Mach-Zender interferometer.

14. An optoelectronic modulator device as claimed in claim 12, wherein the device comprises a directional coupler.

15. A base station of a communication network, the station including at least one optoelectronic device according to claim 1.

16. A communication network including at least one optoelectronic device according to claim 1.

17. Use of a Resonant Tunnelling Diode (RTD) structure to switch an electric field in a semiconductor waveguide and thereby alter a refractive index of the semiconductor waveguide via the electro-optic effect.

18. Use of a Resonant Tunnelling Diode (RTD) structure as claimed in claim 17, wherein the semiconductor waveguide consists of a core of semiconductor surrounded by a lower refractive index material.

19. Use of a Resonant Tunnelling Diode (RTD) structure as claimed in claim 17, wherein the core semiconductor is selected from a semiconductor alloy or semiconductor nanostructure such as a Single or Multiple Quantum Wells (MQWs).

20. Use of a Resonant Tunnelling Diode (RTD) structure as claimed in claim 17, wherein the RTD consists of semiconductor layers which employ quantum mechanical tunnelling between layers to produce a device which has a current voltage characteristic that has a negative differential resistance.

21. Use of a Resonant Tunnelling Diode (RTD) structure as claimed in claim 17, wherein the RTD switched electric field producing the change in refractive index is used in the optical waveguide to produce a controllable phase change in the light propagating in the waveguide in use.

22. Use of an RTD structure to switch an electric field in a semiconductor material and thereby alter the refractive index of the semiconductor via the electro-optic effect and consequently control the phase of a light beam passing through the material.

23. Use of semiconductor alloys and/or semiconductor nanostructures such as Quantum Wells (QW) that have a bandgap selected to increase the electro-optic effect at any wavelength of interest in combination with an RTD to switch the electric field.
